(19) United States
(12) Patent Application Publication
(10) Pub. No.: US 2025/0122104 A1
(43) Pub. Date: Apr. 17, 2025

(54) System for Flow-Controlled Material Dosing for Use with Sedimentation Tanks

(71) Applicant: Clarified Waters, LLC, Gibsonia, PA (US)

(72) Inventor: Christopher Platt, Gibsonia, PA (US)

(73) Assignee: Clarified Waters, LLC, Gibsonia, PA (US)

(21) Appl. No.: 18/911,213

(22) Filed: Oct. 9, 2024

Related U.S. Application Data
(60) Provisional application No. 63/589,808, filed on Oct. 12, 2023.

(51) Int. Cl. C02F 1/52; B01D 21/01; B01D 21/34; B01F 23/50; B01F 25/51; B01F 25/53; B01F 35/21; B01F 35/221; B01F 35/71; B01F 101/00; C02F 1/00; C02F 1/68

(52) U.S. Cl. CPC C02F 1/5227; B01D 21/01; B01D 21/34; B01F 23/56; B01F 25/51; B01F 25/53; B01F 35/2112; B01F 35/2211; B01F 35/71731; B01F 35/7176; C02F 1/687; B01F 2101/305; C02F 2001/007; C02F 2209/40; C02F 2209/42

(57) ABSTRACT

A system for use introducing materials, such as powdered flocculants, can be used with a sedimentation tank. The system includes a bypass circuit for directing water from an inlet of the sedimentation tank to a dosing tank, where the material is added. A pump redirects water from the dosing tank back into the inlet of the sedimentation tank. A metering unit an controller can be used to control the amount of material dispensed into the dosing tank. A series of valves, float switches, and flow meters can be used to control the flowrate and operation of the system.

### CROSS-REFERENCE TO RELATED APPLICATIONS

This application claims the benefit under 35 U.S.C. § 119 of U.S. Provisional Application Ser. No. 63/589,808, filed on Oct. 12, 2023, which is incorporated herein by reference.

### STATEMENT REGARDING FEDERALLY SPONSORED RESEARCH

Not applicable.

### BACKGROUND OF THE INVENTION

The present disclosure generally relates to systems for material dosing in sedimentation tanks. More specifically, the disclosure relates to a system capable of introducing materials, such as flocculants, into a pressurized wastewater stream entering a sedimentation tank.

State and federal rules, such as the Clean Water Act, regulate the discharge of wastewater into public waterways. Wastewater can be generated from construction, mining, and manufacturing activities, among others. To comply with these rules, various wastewater treatment technologies are employed, from simple retention ponds and silt fences to full-scale water treatment facilities. In some settings, sedimentation tanks are employed because they offer reduced size and portability compared to the alternatives. A sedimentation tank can be a portable unit that contains a wastewater inlet, a settling tank portion, a clean water outlet, and a sludge outlet. The sludge comprises the sediment and particles removed from the incoming wastewater stream and is removed from the sedimentation tank in a concentrated form, leaving cleaner water exiting the sedimentation tank from the clean water outlet. An example of a sedimentation tank is shown in U.S. Patent Publication No. US 2023/0390671 A1, which is incorporated by reference herein.

Due to the reduced size of a sedimentation tank compared to a retention pond, which can span several acres and rely on gravity alone for settling, the sedimentation tank employs various technical features to expedite the settling process in a much smaller area. Examples include lamella separators disposed in the settling tank portion and chemical flocculants, which are mixed with the incoming wastewater and adhere to the sediment, making the particles heavier and quicker to settle. Dosing the wastewater with the correct amount of flocculating agents is necessary to ensure adequate settling in the settling tank portion of the sedimentation tank. However, prior systems introduced flocculating agents in a manner that did not offer precise control of the amount of flocculant introduced. For example, the system disclosed in U.S. 2023/0390671 employed a long open mesh tube filled with a dissolvable flocculating agent placed in the path of the incoming wastewater. As wastewater would enter the sedimentation tank past the mesh tube, the flow of water would scour the flocculating agent from the solid block of flocculant contained in the tube. This imprecise and uncontrollable method could lead to effluent still contaminated with sediment due to insufficient flocculant. Therefore, it would be advantageous to develop a system for controllably dosing wastewater entering a sedimentation tank with flocculants and other materials.

### BRIEF SUMMARY

According to embodiments of the present disclosure is a system for dosing materials in a sedimentation tank. According to one embodiment, the system comprises a bypass circuit, or section of pipe, directing wastewater from the inlet of a sedimentation tank. The bypass feeds a portion of the wastewater into a dosing tank, where the wastewater mixes with flocculant or other material added to the tank. The flocculant can be added as a powder using a hopper and a metering unit to precisely control the amount added. The wastewater dosed with flocculant is then returned through the bypass circuit into the main branch of the wastewater flow.

### BRIEF DESCRIPTION OF THE SEVERAL VIEWS OF THE DRAWINGS

FIG. 1 is a schematic view of a system for material dosing according to one embodiment.

FIG. 2 shows the system incorporated to an example sedimentation tank.

### DETAILED DESCRIPTION

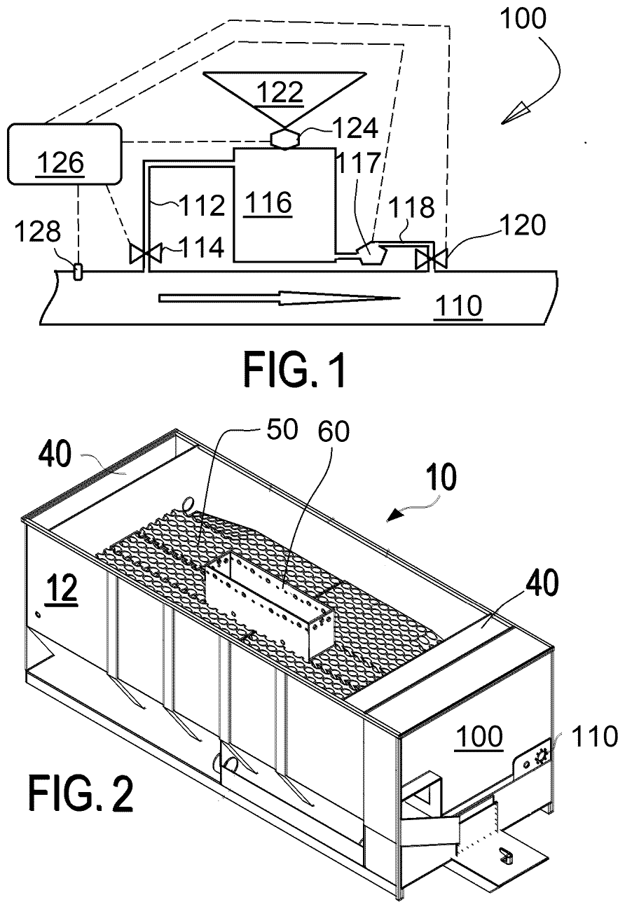

According to embodiments of the disclosure is a system 100 comprising a bypass circuit 112 directing wastewater from an inlet 110 or main line to a dosing tank 116. The wastewater in the dosing tank 116 mixes with a material, such as a flocculant, and is returned to the wastewater inlet 110. The system 100, as shown in FIG. 1, may further include an inlet valve 114 near the proximal end of the bypass feed 112 or the junction between the inlet 110 and the bypass circuit 112. The system 100 may also include an outlet valve 120 near the distal end of the bypass circuit 112, where the bypass circuit 112 re-connects to the inlet 110. Here, proximal end refers to the portion of the bypass circuit 112 where the wastewater first enters from the inlet stream 110 and the distal end refers to the portion where the wastewater reenters the inlet stream 110 from the bypass circuit 112. The water in the bypass feed 112 flows in one direction given that the wastewater stream is typically pressurized. To assist with the flow of the wastewater back into the pressurized inlet stream 110, the system 100 may also include a pump 117. When a pump 117 is used, the wastewater can be directed through an optional outlet feed 118 into the inlet 110.

The material introduced into the wastewater can be a flocculant or other materials, such as pH stabilizers, disinfectants, emulsifiers, acid mine drainage treatments, and other similar materials that are used to treat water. Flocculants may include chemicals, such as polyacrylamide, carboxymethyl cellulose, and polyanionic cellulose, and natural elements and minerals, such as bentonite clays. Often, flocculants are supplied as solids, either as a monolithic brick or a powder. As noted above, issues exist with trying to accurately and precisely meter the correct amount of flocculant when using a solid brick of flocculant. As a result, the present system 100 utilizes a hopper 122 to store and distribute powdered material into the wastewater.

While using a powder allows more control over the amount of flocculant dosed into the wastewater, using this form presents certain challenges. For example, if the flocculant is not retained in the dosing tank 116 for a sufficient length of time because the flowrate is too high, it will not activate and will float on top of the water in the dosing tank 116. Conversely, if the flocculant is retained in the dosing tank 116 too long because the flowrate is too low, it will congeal and clog the pump 117, bypass circuit 112, outlet feed 118, outlet valve 120, or the dosing tank 116 itself. The metering unit 124 and controller 126 can be used to introduce the correct amount of flocculant into the dosing tank 116 and to control the flowrate of water through the tank 116.

Additionally, the problems with thoroughly mixing the flocculant without creating a clog can be mitigated by ensuring thorough mixing within the dosing tank 116. More specifically, the flow of wastewater into the dosing tank 116 can be configured to create a turbulent flow within the tank 116. Given that the bypass circuit 112 is pulling water from the main inlet 110 of the sedimentation tank 10, which can be fed by an inlet pump at 5-15 pounds per square inch (psi) of pressure, precautions should be made to prevent splashing and water-laden air currents from in-rushing water in the vicinity of the hopper 122, which could cause the powdered material to clump and aggregate in the hopper 122, preventing controlled metering into the dosing tank 116.

Within the dosing tank 116, the water is at a lower pressure than the inlet 110. Thus, to reinject the dosed wastewater into the inlet 110 or main wastewater stream of the sedimentation system 10, the water exiting the bypass circuit 112 is pumped at a pressure higher than the pressure of the inlet 110 at the distal end of the bypass circuit 112, or the outlet feed 118 depending on the configuration. As such, pump 117 pulls water from the dosing tank 116 and directs it into the inlet 110 and this flow of dosed water can be controlled by valve 120. In one embodiment, the bypass circuit 112 reinjects the dosed wastewater at a point in the sedimentation system 10 that allows continued mixing of the water and flocculant prior to entering the settling tank portion of the system 10. For example, the dosed wastewater may enter the system 10 prior to any turbulation piping or mixing wells 40, as shown in FIG. 2, included in the sedimentation system 10.

Referring again to FIG. 1, the inlet valve 114 can be used to control the flow of water into the dosing tank 116. As previously discussed, the flowrate of water within the dosing tank is important to prevent incomplete mixing (i.e. flowrate too high) or coagulation of the flocculant (i.e. flowrate too low). In a typical sedimentation tank 10, the flowrate of wastewater into the system 10 is around 100-500 gallons per minute. The bypass circuit 112 redirects 5-10% of this flowrate into the dosing tank. Thus, if the flowrate through the inlet 110 is 400 gallons per minute, the flowrate through the bypass circuit will be about 20-40 gallons per minute. While a larger percentage of wastewater can be directed through the bypass circuit 112 in certain applications. this would necessitate a larger overall system 100, which may decrease the overall volume available for the settling tank portion of the sedimentation system 10. As a result, 5-10% diversion permits adequate dosing for the given flowrate of wastewater to be treated in the sedimentation tank 10.

To prevent overflowing of the dosing tank 116, a float valve can be used as the inlet valve 114 to control the amount of water entering the dosing tank 116. For example, a float valve has a component that floats on the surface of water and will shut a connected valve once it reaches a certain height. In this embodiment, the float valve 114 will terminate flow into the dosing tank 116 prior to the water level reaching the top of the tank 116. Similarly, a float switch can be used to control the pump 117, which can be a submersible pump disposed in the dosing tank 116, and to control the metering unit 124. The metering unit 114 controls the dosing of powdered material from the hopper 122 into the dosing tank 116. By using the float switch, powdered material will not be dispersed into the dosing tank 116 unless water is present, which can prevent clogs and dry powder entering the pump 117. Also, by connecting the pump 117 to the float switch, flow within the dosing tank 116 can be improved by ensuring a constant flow out of the tank 116, thereby preventing a trigger of the float valve 114 and a restriction of flow into the tank 116. In an alternative embodiment, a flow switch, which detects the presence of water flowing into the dosing tank 116, rather than a volume of water in the tank 116.

In addition to the float switch and float valve 114, the flowrate of water into the out of the dosing tank 116 can be controlled with a controller 126. The controller 126 may comprise a controller, a microcomputer, a microprocessor, a microcontroller, an application specific integrated circuit, a programmable logic array, a logic device, an arithmetic logic unit, a digital signal processor, or another data processor and supporting electronic hardware and software. In one embodiment, the controller 126 is connected to flow sensors, flow meters 128, electronic valves 114/120, and the metering unit 124. By controlling the metering unit 124, which may comprise an auger and electric motor disposed within the hopper 122, the correct amount of flocculant can be added to the dosing tank 116 for a measured flowrate within the inlet 110. The correct amount of flocculant will be based, in part, on the flowrate of wastewater in the inlet 110 and the sediment load of the water. For example, if the flowrate of water in the inlet 110 is 400 gallons per minute, the flocculant would be added at a rate of 1 ounce per minute (or 4 pounds per hour) for an average sedimentation load in the wastewater.

In the example provided above, the rate of flocculant addition to the dosing tank 116 is matched to the flowrate in the inlet 110. Thus, the size of the system 100 should be configured to allow the appropriate flowrate through the dosing tank 116 for the amount of flocculant being added. That is, the size should be in a range to permit adequate mixing without clogging. Further, with this system 100, the amount of flocculant added to the sedimentation tank 10 can be adjusted if the effluent (or clarified water exiting the tank 10) remains loaded with sediment. In this example, the rate of 1 oz./min. would be increased to 1.25 oz./min. The configuration of the system 100, including the bypass circuit 112 and dosing tank 116, will allow a range of flocculant addition rates.

In the system 100 described herein, the flocculant is handled in a powdered form until the instant it is needed in the sedimentation system 10. While prior systems have attempted to inject the flocculant as a liquid or as a pre-hydrated solid, these systems tend to be less effective because the flocculant will lose its ability to adhere to sediment particles once activated, particularly for flocculants that include polyacrylamide. As such, the flocculant is hydrated and activated in the dosing tank 116 just prior to entering the settling tank portion of the sedimentation tank 10.

As described herein, the sedimentation tank 10 is configured for use as a sediment trap. The fluid treated in operation as a sediment trap is water runoff, however the system 10 has broader application as a settling tank for other fluids. In the description of the system 10 as a sediment trap, wastewater and fluid may be used interchangeably, but this language does not limit the potential applications of the system 10, such as a general solids separator that could be used in industries such as wastewater, sewer authorities, municipalities, and similar industries. The tank system 10 may include a transportable or portable housing 12 having a settling tank portion within the housing 12, agitation piping and mixing wells 40, a lamella separator 50 within the settling tank, and a spillway 60 for collecting the effluent.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A system for dispensing a material into a pressurized flow of a liquid comprising:
a branch circuit configured to extract liquid contained within a main line of the pressurized flow;
a dosing tank that receives the liquid from the branch circuit;
a hopper positioned near the dosing tank, wherein the hopper is configured to hold the material;
a metering unit configured to controllably dispense the material from the hopper to the dosing tank; and
a pump for redirecting the liquid from the dosing tank into the main line.

2. The system of claim 1, further comprising:
a controller adapted to control operation of the metering unit.

3. The system of claim 1, wherein the pump pressurizes the liquid in the distal end of the branch circuit to a higher pressure than the liquid in the main line.

4. The system of claim 1, further comprising:
a float valve in operative communication with the dosing tank, wherein the float valve restricts the flow of liquid into the branch circuit depending on a level of the liquid in the dosing tank.

5. The system of claim 1, further comprising:
a float switch disposed in the dosing tank, wherein the float switch enables operation of the pump when a liquid is present in the dosing tank.

6. The system of claim 1, wherein the system is integrated into a sedimentation tank.
